(19) United States
(12) Patent Application Publication
(10) Pub. No.: US 2025/0305474 A1
(43) Pub. Date: Oct. 2, 2025

(54) Wave Energy Converter

(71) Applicant: Oscillating Wave Energy Limited, Douglas (IE)

(72) Inventors: Istvan Lakos, Passage West (IE); Bela Balogh, Middleton (IE)

(21) Appl. No.: 18/778,303

(22) PCT Filed: Jan. 27, 2023
(86) PCT No.: PCT/EP2023/052091

§ 371 Date: Jul. 19, 2024

(30) Foreign Application Priority Data
Jan. 27, 2022 (IE) 2022/0018

(51) Int. Cl. F03B 13/18

(52) U.S. Cl. CPC F03B 13/1895; F05B 2210/11; F05B 2220/706

(57) ABSTRACT

The disclosure relates to a high efficiency, low maintenance, simple, pressure receptacle wave energy converter device comprising a converter/generator unit such as a flywheel aided generator (which is located, in use, on a floating body), a buoyancy aided pressure receptacle unit located, in use, below the surface of the water, and a means of connecting/tethering the pressure receptacle with the converter. The device permits the capture of buoyant wave energy imparted to the pressure receptacle and the conversion of the captured energy into electrical energy thus directly producing or storing electrical energy from the captured kinetic energy of the waves.

The present invention defines a highly efficient method of capturing wave energy, harnessing different wave heights, frequencies and ocean swells at different sea conditions.

The present invention offers a cost effective and low maintenance design, with few moving parts and self-directing capabilities, suitable for either close-to-shore operations or deep sea operations. The present invention is a highly efficient but simple system, with high conversion ratio and energy generation. In particular, the small footprint of the invention makes it uniquely suitable for environments in which larger more complex devices would not be appropriate.

According to a first aspect of the invention there is provided a device for harnessing kinetic wave energy and converting said kinetic wave energy into electrical energy,
the device comprising a pressure receptacle comprising;
an impervious sidewall through which fluids cannot pass;
at least one integrated buoyancy unit on the impervious sidewall; a base which is connected to the sidewall to form a closed end; and an open upper end;
a tethering cable;
a converter for converting kinetic energy translated from wave motion into electrical energy; and a means for connection to a floating body;
wherein, in use, the pressure receptacle is connected in tension within a water column via the tethering cable to a tethering mechanism in the converter which is
located on a floating body;
such that,
fluctuations of waves cause movement of the floating body on which the converter is located, thus varying the tension in the tethering cable in a cyclical manner to convert kinetic wave movement into electrical energy, whereby, a flow of water through the pressure receptacle on upward wave movement increases pressure on the pressure receptacle thus resulting in an extension of the tethering cable and flow of water through the pressure receptacle on downward wave movement decreases pressure on the pressure receptacle thus resulting in a retraction of the tethering cable.

Preferably, the base of the pressure receptacle comprises at least one check valve.

Preferably, the at least one check valve comprises a passive or active means of modulation.

Preferably, the converter comprises a flywheel and generator.

Preferably, the converter comprises a hydraulic arm.

Preferably, the tethering cable comprises a pulley mechanism.

Preferably, the tethering cable is fitted with a variable tension mechanism.

Preferably, the integrated buoyancy unit comprises non elastic sidewalls.

Preferably, the pressure receptacle is made from high strength materials.

Preferably the pressure receptacles are integrated together into a single unit.

Preferably, the device comprises a plurality of pressure receptacles.

Preferably, the device comprises a vessel.

Preferably, the device comprises a plurality of pressure receptacles and one or more converters located on a floating body.

Preferably, a farm is provided comprising a plurality of devices wherein the devices are interconnected.

Preferably, there is provided a method of harnessing wave energy from a particular location with the device and converting said kinetic wave energy into electrical energy, the method comprising the following steps:
i. assessing the wave environment of the location in order to predict wave types and wave heights;
ii. based on the predicted wave environment, configuring the device with a specific pressure receptacle volume, a tethering cable of suitable length and generator of suitable capacity;
iii. connecting the floating body to a mooring point such that the device is fixed in the location and able to sway freely; and
iv. connecting the converter to a generator, electrolysis apparatus, battery or other means of distributing or storing the electrical energy.

Preferably, a generator is connected to flywheel in order to generate electricity from the harnessed wave energy.

Preferably, a processor is provided to control the working parameters of the generator for various different wave conditions.

Preferably, motion sensors are provided in order to monitor the movement of the waves.

Preferably, sensors are provided to monitor the velocity of the components of device.

Preferably, sensors are provided to monitor the energy generated by the device.

Preferably, a three axis accelerometer is provided.

Preferably, all the components of the device are produced from recycled material.

### BACKGROUND ART

The best property of the wave energy (especially swells) is that it will never run out. There will always be waves forming in large bodies of water, crashing upon the shores of nations near populated coastal regions. Unlike fossil fuels, which are running out in some places in the world, just as quickly as people can discover them; unlike ethanol, a corn product; waves and swells are not limited by a season.

They require no input from man to make their power, and they can always be relied upon.

Also, unlike fossil fuels, creating power from waves creates no harmful by-products such as gases, waste, and pollution. The energy from waves can be taken directly into electricity producing machinery and used to power generators and power plants nearby. In today's energy-powered world, a source of clean energy is hard to come by.

Another benefit of using wave energy is its nearness to places that can avail of it. Lots of big cities and harbours are next to the ocean and can harness the power of the waves for their use. Coastal cities tend to be well-populated, so lots of people can benefit from wave energy plants.

The biggest advantage of wave power in comparison to most other alternative energy sources is that it is easily predictable and forecasting can be used to calculate the amount of energy that can be produced at a certain location. Wave energy is consistent and proves much more reliable than other sources that are dependent on wind or sun exposure.

Unlike fossil fuels, which cause massive damage to land and the seas/oceans (they can leave large holes while extracting energy from them and cause environmental disasters), wave power does not cause any damage to the earth. Waves exist, regardless of whether they are harvested for energy or not. Wave energy is safe, clean, and one of the preferred methods to extract energy from the ocean.

Wave energy is a very reliable source of energy. It is because waves are almost always in motion. Although there are ebbs and tides, the average motion always remains. Thus, energy can be harnessed continuously. It is a fact that the amount of energy that is produced and transported through the waves varies from season to season and from year to year, however, energy production from waves is continuous.

As clean as wave energy is, it still creates hazards for some of the creatures near it. Large machines have to be put near and in the water in order to gather energy from the waves. These machines disturb the seafloor, change the habitat of the marine life and create noise that disturbs the sea life around them. There is also a danger of toxic chemicals that are used on wave energy platforms spilling and polluting the water near them.

Current wave power technologies are highly dependent on wave speed, wavelength wave height and water density. They normally require a consistent flow of powerful waves to generate a significant amount of wave power. Some areas experience unreliable wave behaviour, and it becomes unpredictable to forecast accurate wave power and, therefore, cannot be trusted as a reliable energy source, unless the device used is flexible in terms of energy production.

The future of wave energy is very bright. This form of energy has a lot of potential. With awareness growing among the masses regarding renewable and non-renewable resources, it is essential that the masses lean towards the more sustainable resources of energy.

### OBJECTIVE OF THE INVENTION

The pressure receptacle wave energy converter, hereinafter referred to as the device, overcomes most of the challenges which are currently topical in the field of energy generation. The device offers an economically viable option not only over fossil fuels, but over other wave energy converters and renewable technologies, as all currently available wave energy converters are limited by design in terms of
efficiency, energy generation and/or cost.

Most countries lack the necessary hours of sun to propel photovoltaic energy or they lack steady and forceful winds, geothermal or hydropower although as 55% of the world's population resides near a coastline, this could be a viable option to generate sustainable and reliable source of energy from ocean and sea swells/waves.

A common problem for most wave energy converters, is that they are designed for certain sea conditions for efficiency, whereas the present invention is suited to harness all of the energy, regardless of the conditions.

As most wave energy converters require anchoring of the device vertically to the seabed, they are limited to be efficiently used with changing weather conditions, changing tides and wave patterns. The present invention uses a technique involving a buoyancy aided pressure receptacle unit, suspended in a body of the water, under a high buoyancy floating body, where vertical anchoring of the system to the seafloor is not required. It will be appreciated that the term floating body can refer to a device specific floating platform or it could be a standard seafaring vessel. The present invention remains suspended and stationery in the body of water freely, without disturbing the environment or the seabed and benefits from sustaining its position regardless of any changes in the conditions above the surface of the body of the water, resulting in energy conversion in the full spectrum of wave/swell heights, patterns and frequencies through its design. As the floating body only requires anchoring from a directional point of view (or the floating body could be connected in a grid in a farm configuration), the floating body has the advantageous ability to rotating 360° around the directional point anchoring, thus accessing a variety of positions depending on changing tides, wave directions, swells and wind.

Most wave energy generators are too complex and therefore too expensive to produce and maintain, as they are subjected to corrosive elements under water. The design in question aims to reduce the complexity to an acceptable level thus increasing reliability and productivity, at a highly competitive cost.

Most traditional wave energy converters utilize the upward buoyant pressure of waves to achieve horizontal tension between the floating body and the seafloor or they use the pressure differential of passing waves. The current invention aims to use the buoyant lifting pressure of the passing waves/swells which lifts the floating body thus harnessing all the buoyant energy resulting from a cyclical vertical movement between the submerged buoyancy aided pressure receptacle and the floating body, from the smallest to the largest divergence, all across the spectrum.

### BRIEF DESCRIPTION OF DRAWINGS

Certain preferred embodiments of the present invention will now be described, by way of example only, with reference to the accompanying drawings in which;

FIG. 1a illustrates one of the variations of the design of the pressure receptacle 101 of the device 100, with a parabolic bottom plate, side walls (with integrated buoyancy aid(s) 6), a skirt, and triangular plate check-valves 14 integrated into the bottom plate;

FIG. 1b illustrates a perspective view from above of the pressure receptacle of FIG. 1a;

FIG. 1c illustrates a plan view of the pressure receptacle of FIG. 1a;

FIG. 1d illustrates a perspective view from below of the pressure receptacle of FIG. 1a;

FIG. 2 illustrates a simplified schematic of the device 100 comprising the pressure receptacle 101 with integrated buoyancy aid 6 and integrated check valves 14, a tethering cable 4, an optional flywheel and a converter 10, and a tension reeling device 8;

FIG. 3 illustrates the device 100 in use in the inertial phase at the trough of a wave, where the pressure receptacle 101 is tethered to the minimum distance from the floating body/vessel 16;

FIG. 4 illustrates the device 100 in use in the reeling out phase wherein the floating body 16 is at the crest of a wave. The pressure receptacle 101 remains in position, but the tension reeling cable 4 is being reeled out from the tension reeling device 8 thus rotating the converter/generator 10;

FIG. 5 illustrates an industrial variation of the floating body 16 wherein a large pressure receptacle 101 is suspended from a floating body 16 and wherein the large pressure receptacle 101 comprises integrated buoyancy aids 6 in the front and the back, a piercing bow to dissipate frontal underwater current if needed, stabilizing wings next to the tethering points and multiple check-valves 14 (the shape and size of both the floating body 16 and the pressure receptacle 101 are matched and therefore the pressure receptacle 101 could be extracted or retracted to regain mobility, if needed);

FIG. 6 illustrates an alternative embodiment of the device 100 according to the invention (to be used in conditions where pitching and rocking motions are dominant) wherein the pressure receptacles 101 comprise parabolic bases and the pressure receptacles 101 are arranged in a configuration with a 45 degree angle to the central axis of the floating body 16;

FIG. 7 illustrates an alternative embodiment of a device 100 according to the invention which is capable of submersion if sea/weather conditions require, wherein the floating body 16 is an inflatable/deflatable balloon type of body comprising an integrated power generator 10 and flywheel, a tension reeling unit 8 and a tethered pressure receptacle 101; and

FIG. 8 illustrates the device 100 of FIG. 7 wherein a plurality of floating bodies 16 are joined together to form a wave energy conversion farm.

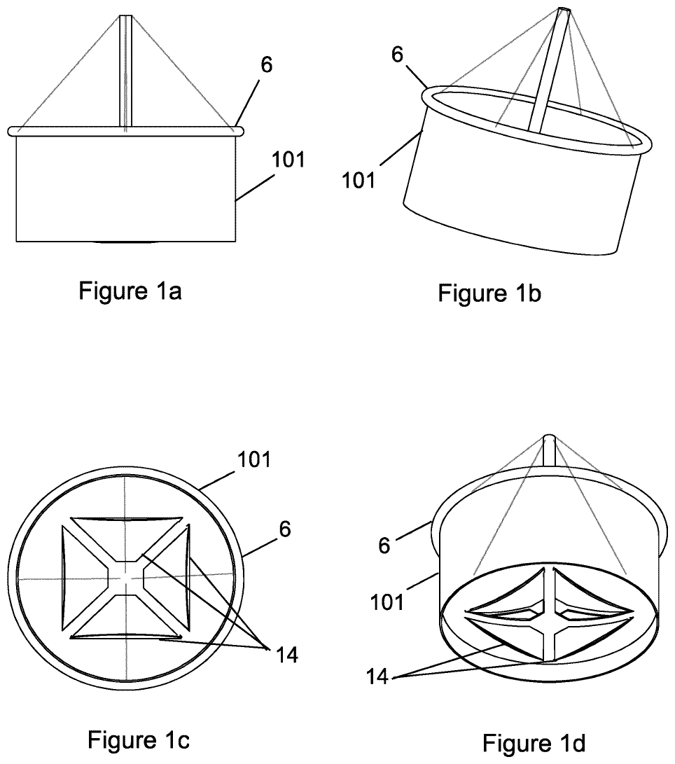

### DETAILED DESCRIPTION

Various embodiments of the present invention will now be described in detail with reference to the drawings, where like reference numerals represent like parts and assemblies throughout the several views.

Referring now the accompanying drawings, there is illustrated a variety of embodiments of a device, generally indicated as 100, comprising a pressure receptacle 101 with integrated buoyancy aids 6, attached to a converter 10 in the form of a flywheel and/or generator. The pressure receptacle 101 comprises sidewalls and a base. One end of the pressure receptacle 101 is open thus allowing water into the pressure receptacle 101. The other end of the pressure receptacle 101 is closed as the base is attached to the sidewalls. The closed end of the pressure receptacle 101 ensures that water stays in the pressure receptacle 101 thus allowing pressure to build up in the pressure receptacle 101.

The shape of the pressure receptacle 101 with vertical sidewalls is the optimal configuration. Vertical sidewalls ensures that the mass of water pressure is captured when the water enters the pressure receptacle 101. In a further embodiment, a minimal lean of the sidewalls, towards the middle of the pressure receptacle 101, results in a venturi effect during wave-action, resulting in higher efficiency.

The concave base on the bottom end of the pressure receptacle 101 serves the purpose of structural strength of the pressure receptacle 101 during wave motion. The concave base may also channel the water pressure to close the check-valves 14 as fast as possible (in embodiments where the check valves 14 are present).

By incorporating the buoyancy aids 6 into the pressure receptacles 101, the design is very simple and of low complexity thus diminishing the overall mass of the pressure receptacle 101 and therefore the strain on the tethering cable 4, so that the weight of the pressure receptacle 100 is minimal, although the mass of water pressure can be scaled up easily.

The device 100 is designed to easily and efficiently capture the energy of increased buoyant pressure of waves affecting the floating body 16 (for example capillary waves or gravity surface waves and swells), amplify the energy and distribute the energy into a suitable energy conversion means in order to convert the energy into electrical energy or store the energy. Due to the highly adaptable nature of the device 100, the device 100 is suitable for a wide variety of sea and lake applications ranging from close to shore locations to deep sea. The device 100 can be employed to capture energy from a wide variety of waves of different wave heights, including capillary waves (rolling motion), chop and gravity surface waves/swells.

The design 100 of the pressure receptacle 101 means that the pressure receptacle 101 serves as an artificial rigid anchoring point. It is not a damper/heave plate.

The device 100 is self adjusting into wave and wind direction, as the receptacles are not connected to the seafloor.

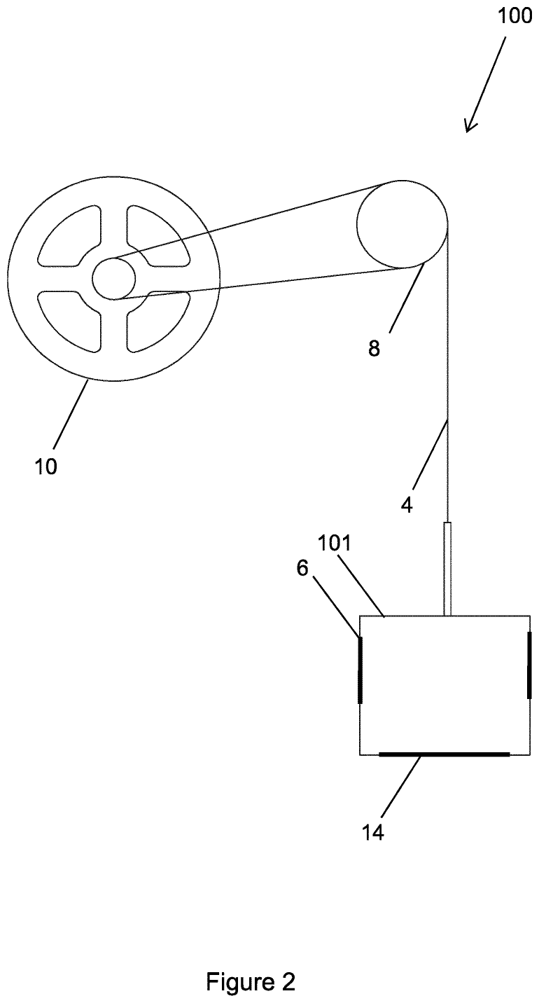

FIG. 2 illustrates a simplified schematic view of a preferred embodiment of a device 100 according to the present invention, wherein the device 100 is attached to a converter/generator 10 such that the converter/generator 10 converts the wave energy of the wave as harnessed by the device 100 into an energy form that can be stored or input into a component for use.

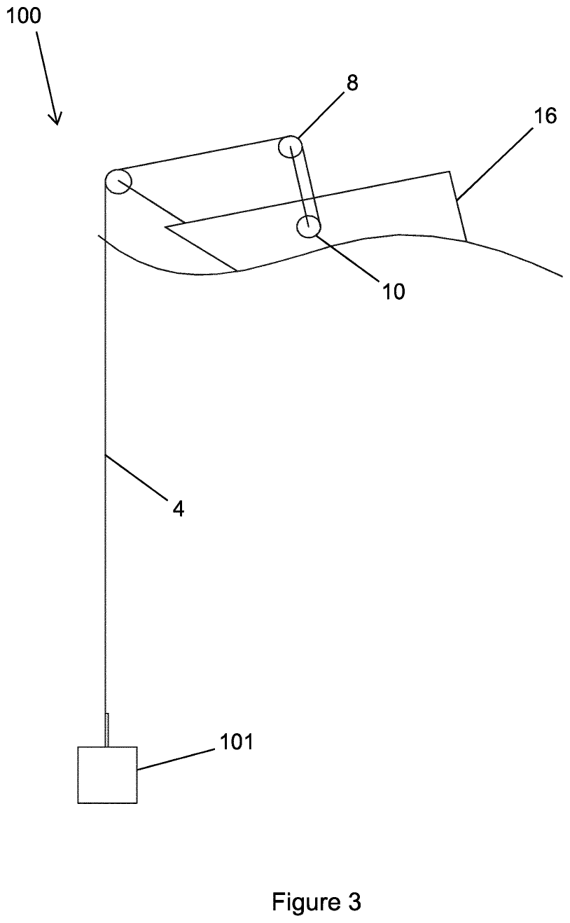

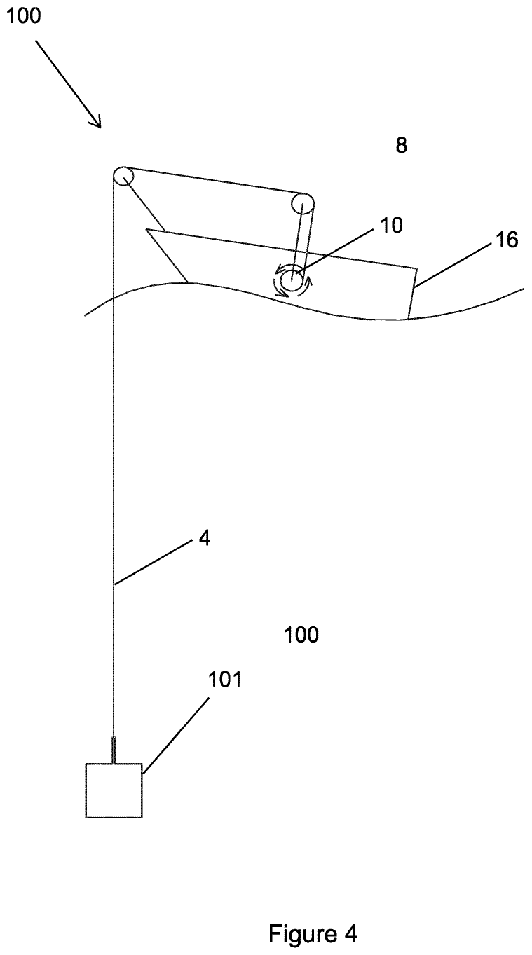

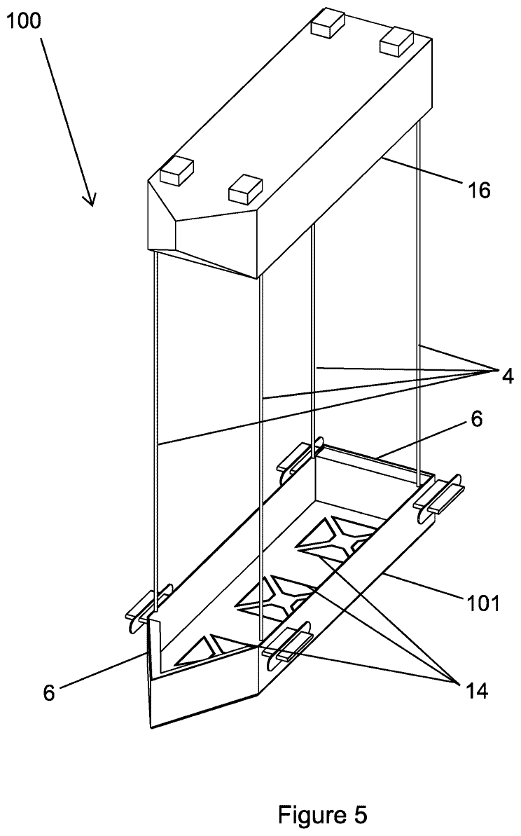

As illustrated in FIGS. 3 and 4, in its simplest form, the invention comprises the pressure receptacle 101 with the at least one integrated buoyancy aid 6 and, optionally the at least one check valve 14, the tethering cable 4, the tension reeling system 8 and the converter/generator 10, wherein the tethering cable 4 is an elongated length of high tensile strength material (such as for example stainless steel wire or polypropylene rope) which connects the pressure receptacle 101 to the floating body 16. The term cable will not be construed as limiting and the feature referred to as a tethering cable 4 may alternatively be wire, cable or a rope provided that it is of suitable tensile strength to withstand the tension reeling activity of the device 100. It is important that the tethering cable 4 exhibits minimal to no elasticity, in order for all the energy of the waves to be captured by the device 100 and the floating body 16. The tension on the tethering cable is controlled through a tension reeling system 8. The tension reeling system 8 is preferably constructed from spring loaded tensioning, however, the tension reeling system 8 is not limited to spring loaded tensioning and it will be appreciated that other forms of tensioning could be used.

As illustrated in FIG. 3 and FIG. 4, the pressure receptacle 101 is connected to a floating body 16. The floating body 16 may be a floating buoy, a vessel, a platform, a ship or any other type of floating body. The device 100 may be integrally connected to the floating body 16 or the floating body 16 may be provided separate to the device 100 and the device 100 may simply be located on the floating body 16.

In use, pressure receptacle 101 is located at a submerged depth below the surface of the body of water, in a depth where surface waves have no effect on the pressure receptacle 101. In this context, body of water will be understood to mean a lake or sea or ocean. The upper end, or plane, of the pressure receptacle 101 is open. The combination of an open upper end and at least one integrated buoyancy aid 6 balances the device 100 such that the pressure receptacle 100 net weight is minimal and the force on the tethering cable 4 not so significant that it retracts the tethering cable 4 from a limiter which is place on the tethering cable 4. The distance of extended tethering cable 4 is limited by a limiter on the tethering cable 4.

The minimum distance between the pressure receptacle 101 and the tension reeling device 8 can be easily adjusted by automation or by historical weather patterns/wave-swell data. With the above method, the pressure receptacle 100 remains vertically close to stationery in the body of the water and unaffected by the waves.

At the state of poise/inertia the tethering cable 8 is pulling on the buoyancy aided pressure receptacle 101 with equal force of strength to suspend the buoyancy aided pressure receptacle 101 thus compensating the pressure receptacles 101 weight and tethering at the minimal distance. In this position, the pressure receptacle 101 is ready to receive the water pressure with its check valves closed by inertial water pressure and gravity. The check valve 14 is a simple valve which allows a flow of water to pass through the pressure receptacle 101 in one direction (when the check valve is in the open position) but prevents a flow of water passing through the pressure receptacle 101 in an opposite direction (when the check valve is in the closed position). Typically, the check valve 14 is a pivotable flap. The flap is closed when the flap is in line with the bottom plate of the pressure receptacle 101 and the flap is open when the flap is not in line with the bottom plate of the pressure receptacle 101. It will be appreciated that the flap embodiment is simply one type of check valve and other types of check valves are also considered within the scope of the invention. The check valve 14 may also incorporate a form of passive or active modulation control.

Check valves 14 are suitable for pressure receptacles 101 of certain size, however, it will be appreciated that at a certain magnitude of pressure receptacle 101, the pressure receptacle 101 itself is of a mass such that check valves 14 are no longer required in order reduce upward motion of the pressure receptacle 101. Upscaling the size of the device 100 diminishes the need for check valves 14, as the increased added mass due to the increased size of the pressure receptacle 101, reduces the upward motion of the pressure receptacle 101 and thus the pressure receptacle 101 remains more or less stationery without any check valves 16. Thus, check valves 16 are appropriate for environments where smaller devices 100 are required, however, no check valves 16 are required for devices 100 which are of a larger magnitude.

As the floating body 16 is affected by waves, the floating body 16 may pitch, heave roll, yaw, sway or surge. The floating body 16 pitches and rolls, putting tension on the base of the pressure receptacle 101 or the at least one check valve 14 incorporated into the base (or bottom plane) of the pressure receptacle 101 and therefore also putting tension on the tethering cable 4. As the floating body 16 lifts towards the crest of the wave, the buoyant lifting motion on the floating body 16 creates tension on the pressure receptacle 101, by containing increased water pressure utilizing the pressure receptacle's 101 form, the open receiving upper end of the pressure receptacles 101 and the closed check valve 14 (if present) such that the tethering cable 4 is reeled out from the converter/generator 10, exerting rotational or cyclical movement within the converter/generator 10 thus generating energy which is captured and converted into useable electrical energy.

The energy harnessed by the device 100 and the floating body 16 can be distributed or transmitted by any conventional method of electrical energy distribution or it can alternatively be stored by means of a battery or used in the process of electrolysis. Any power generating means which requires rotation, gyration or motion to generate electricity may be used in conjunction with device 100.

Over the crest of the wave, the floating body 16, due to its mass and the gravitational force pulling on its mass, begins its downward motion, reducing the tension on the pressure receptacle 101. At this stage, the gravitational force on pressure receptacle 100 is greater than the vertical pulling force of the tethering cable 4 and the tension reeling mechanism 8 so the tethering cable 4 is compensated back to its original minimum distance. The length of tethering cable 4 extended is limited by the increasing force of the tension reeling mechanism 8, whilst the check-valves 14 remain partially open due to the downward draught and skirts channelling the body of water below the pressure receptacle 101 through check valves. The open check valves 14 aiding the pressure receptacle 101 to return to its initial position, until the next cycle when the check valves 14 close and the water pressure increases. The above upward and downward motions are repeated in a cyclical matter.

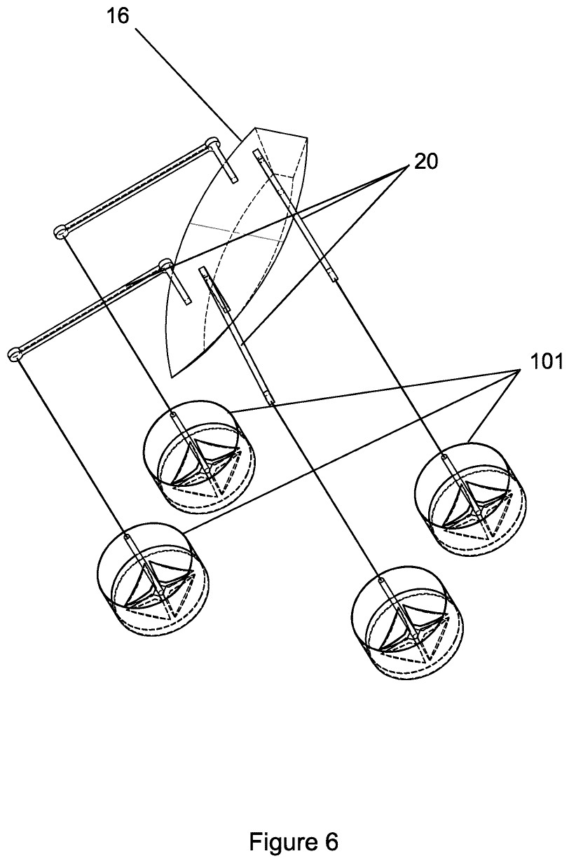

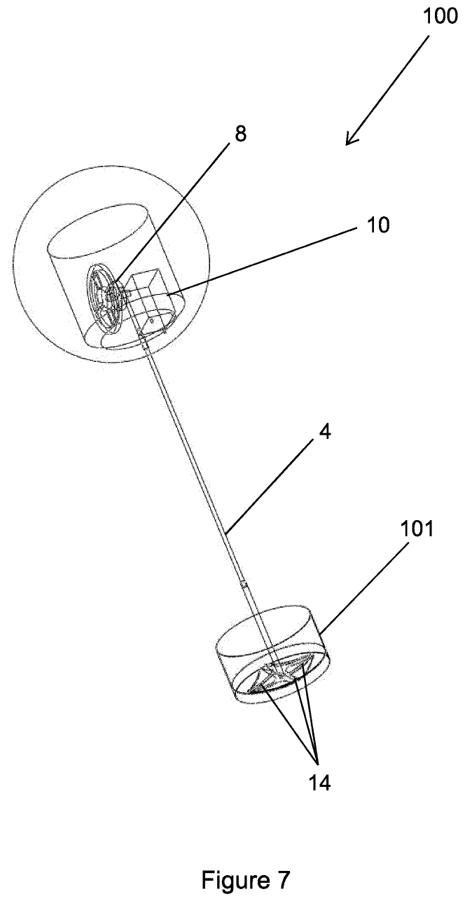

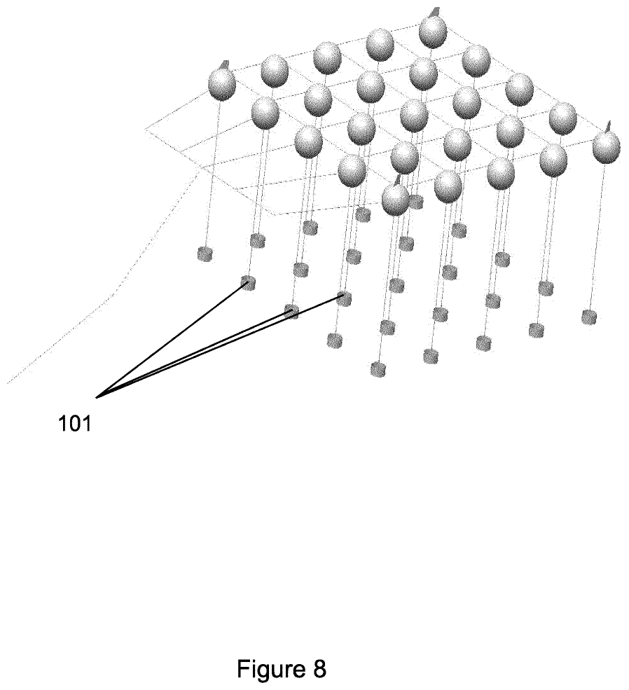

The converter 10 could equally be at least one hydraulic arm 20 as shown in FIG. 6, where the hydraulic arm 20 contracts and retracts in a cyclical manner as the tension on the tethering cable 4 increases and decreases due to the motion of the floating body 16 thus activating a rotor by hydraulic means. The orientation of the hydraulic arms 20 is preferably at an angle of 45° to the centreline of the floating body 16 thus enabling the device 100 to benefit from both pitch and heave motions, thus providing optimal efficiency. The hydraulic arms 20 may additionally comprises vertical extensions. Such a vertical extension increases the height of the centre of gravity of the floating body 16. An increased centre of gravity of the floating body 16 means that the floating body 16 will be more effected by the motion of the waves, and thus rolling motions of the smaller waves will be magnified. The hydraulic arms could also be adjustable such that different orientations can be chosen depending on the environmental conditions.

1. A device (100) for harnessing kinetic wave energy and converting said kinetic wave energy into electrical energy,
the device (100) comprising:
a pressure receptacle (101) comprising;
an impervious sidewall through which fluids cannot pass; at least one integrated buoyancy unit (6) on the impervious sidewall;
a base which is connected to the sidewall to form a closed end; and an open upper end;
a tethering cable (4);
a converter (10) for converting kinetic energy translated from wave motion into electrical energy; and a means for connection to a floating body (16); wherein, in use, the pressure receptacle (101) is connected in tension within a water column via the tethering cable (4) to a tethering mechanism (8) in the converter (10) which, in use, is located on a floating body (16);
such that,
fluctuations of waves cause movement of the floating body (16) on which the converter (10) is located, thus varying the tension in the tethering cable (4) in a cyclical manner to convert kinetic wave movement into electrical energy, whereby, a flow of water through the pressure receptacle (101) on upward wave movement increases pressure on the pressure receptacle (101) thus resulting in an extension of the tethering cable (4) and flow of water through the pressure receptacle (101) on downward wave movement decreases pressure on the pressure receptacle (101) thus resulting in a retraction of the tethering cable (4).

2. The device (100) of claim 1, wherein the base of the pressure receptacle (101) comprises at least one check valve (14).

3. The device (100) of claim 1, wherein the converter (10) comprises a flywheel.

4. The device (100) of claim 1, wherein the converter (10) comprises a hydraulic arm.

5. The device (100) of claim 1, wherein the tethering cable (4) is fitted with a variable tension mechanism.

6. The device (100) of claim 1, wherein the integrated buoyancy unit (6) comprises non elastic sidewalls.

7. The device (100) of claim 1, wherein the at least one check valves (14) comprises a passive or active means of modulation.

8. The device (100) of claim 1, comprising a plurality of pressure receptacles (101) and one or more converters (10) located on a floating body.

9. The device (100) of claim 1, wherein the pressure receptacles (101) are integrated together into a single unit.

10. The device (100) of claim 1, comprising a plurality of pressure receptacles (101) and one or more converters (10) located on a plurality of floating bodies (16).

11. The device (100) of claim 1, comprising a means of attaching the device (100) to a floating body (16).

12. The device (100) of claim 1, wherein the device (100) comprises an inflatable or deflatable submergible floating body (16).

13. The device (100) of claim 1, wherein the device (100) comprises a means of storage or distribution of energy which is connected to the converter (10).

14. A farm device for harnessing kinetic wave energy and converting said kinetic wave energy into electrical energy comprising a plurality of devices (100) according to claim 1, wherein the devices (100) are interconnected.

15. A method of harnessing wave energy from a particular location and converting said wave energy into electrical energy using the device (100) of any one of the preceding claims, the method comprising the following steps:
i assessing the wave environment of the location in order to predict wave types, wave heights and a suitable floating body (16);
ii based on the predicted wave environment configuring the pressure receptacle (101) of suitable size and strength with suitable integrated buoyancy units (6), a tethering cable (4) of suitable length for use with a floating body (16) of suitable buoyancy volume and properties
iii connecting the device (100) to the floating body (16);
iv connecting the floating body (16) to a mooring point such that the device (100) is fixed in the location and able to sway; and
v connecting the converter (10) to any means of storage or distribution of energy.
